(19) United States
(12) Patent Application Publication
(10) Pub. No.: US 2005/0010417 A1
(43) Pub. Date: Jan. 13, 2005

(54) Simplified wireless device pairing

(76) Inventor: David W. Holmes, Sammamish, WA (US)

Correspondence Address: Charles A. Mirho, 112 W. 37th St., Vancouver, WA, 98660, US

(21) Appl. No.: 10/617,437

(22) Filed: Jul. 11, 2003

(51) Int. Cl. G10L 11/00

(52) U.S. Cl. 704/275

(57) ABSTRACT

A wireless device includes pairing information for the wireless device and pairing information for another wireless device. The device includes logic to convert the pairing information for the other wireless device to audible signals, and to communicate the audible signals via a speaker.

### TECHNICAL FIELD

The present disclosure relates to configuration and establishment of secure communications between wireless devices.

### BACKGROUND

Wireless telephones are popular, ubiquitous devices. It is now possible to make and receive phone calls from almost any place in the world. Communication is even possible from remote and undeveloped areas using wireless satellite telephones. Herein, the term wireless telephone refers to any device capable of transmitting and receiving voice and/or data (non-voice) information to and from a network without the use of wires, cables, or other tangible transmission media. So-called cellular telephones are a common example of wireless phones.

Wireless telephones and the networks by which they communicate operate according to various technologies, including analog mobile phone service (AMPS), circuit switching, packet switching, wireless local area network (WLAN) protocols such as IEEE 802.11 compliant networks, wireless wide-area networks (WWAN), short-range RF systems such as Bluetooth, code division multiple access (CDMA), time division multiple access (TDMA), frequency-division multiplexing (FDM), spread-spectrum, global system for mobile communications (GSM), high-speed circuit-switched data (HCSD), general packet radio system (GPRS), enhanced data GSM environment (EDGE), and universal mobile telecommunications service (UMTS). Of course, these are only examples, and other technologies may be employed in wireless communication as well.

Herein, the term ‘wireless device’ is meant to include wireless telephones (including cellular, mobile, and satellite telephones), and also to include a variety of other wireless devices, including wireless web-access telephones, automobile, laptop, and desktop computers that communicate wirelessly, and wireless personal digital assistants (PDAs). In general, the term ‘wireless device’ refers to any device with wireless communication capabilities.

Many companies produce wireless telephones and other wireless devices. Among the more well-known producers are Nokia®, Ericsson®, Motorola®, Panasonic®, Palm® Computer, and Handspring®. A variety of producers also provide wireless devices comprising versions of the Microsoft® Windows® operating software.

In order to provide additional facilities and functions it is common to couple other devices to the wireless phone; e.g. a personal computer, that uses the phone as a modem, or a “handsfree” car kit that allows the phone user to talk without holding the phone to their face. Traditionally, such phone peripherals have been coupled to the phone using a cable. This has the disadvantages both of the physical encumbrance of the cable, and the need to provide cables with different connections to work correctly with the proprietary interfaces on the phones. Bluetooth and similar wireless technologies aim to overcome both these issues, but as they operate over wireless links they often comprise additional features to replicate the security of a physical cable. To implement this secure connection, wireless devices that communicate via Bluetooth and/or other relatively short-range wireless techniques may require “pairing” in order to establish secure communication between the devices. For example, a wireless telephone may be paired with a hands-free (HF) automotive set in order to enable the driver of an automobile to communicate wirelessly without removing his/her hands from the wheel. Pairing may enable secure communication between the wireless phone and the hands-free set by establishing encryption keys that each device may apply to communications directed to the other device. Without pairing, unwelcome parties might be able to take control of the phone or HF set by spoofing the other device.

The pairing process may appear complex to a “first-time” or technically challenged user. The user actions to perform the pairing include: enabling Bluetooth transmission in both devices, rendering one device “discoverable” by the other, causing the other device to “search” for discoverable Bluetooth devices, selecting the correct device from those found, reading or creating and then entering a four-digit “pairing code” on one or both devices. Thus a problem with current pairing techniques is that they involve often complex, synchronized action by the user of the devices. For example, to establish pairing, some phone-HF combinations require numerous button presses applied to both devices in precise sequence. Errors or excessive delays at any point may cause the pairing to fail. The result may be large number of customer service calls to the providers of the phone and/or HF set.

### SUMMARY

The present invention provides benefits over the prior art. A brief summary of some embodiments and aspects of the invention are first presented. Some simplifications and omissions may be made in the following summary; the summary is intended to highlight and introduce some aspects of the disclosed embodiments, but not to limit the scope of the invention. Thereafter, a detailed description of illustrated embodiments is presented, which will permit one skilled in the relevant art to make and use aspects of the invention. One skilled in the relevant art can obtain a full appreciation of aspects of the invention from the subsequent detailed description, read together with the Figures, and from the claims (which follow the detailed description).

In one embodiment, a wireless device includes pairing information for the wireless device and pairing information for another wireless device. The device includes logic to convert the pairing information for the other wireless device to audible signals, and to communicate the audible signals via a speaker.

In another embodiment, a wireless device includes a microphone and logic to convert signals produced by the microphone into control signals, and to apply the control signals to effect pairing of the wireless device with another device.

In another embodiment, a wireless device includes a speaker and logic to identify another wireless device to a network, receive pairing information for the other wireless device from the network, convert the pairing information for the other wireless device to audible signals, and communicate the audible signals via the speaker.

In another embodiment, a wireless device includes a microphone and logic to convert signals produced by the microphone into speech signals, communicate the speech signals to a network, receive control signals corresponding to the speech signals from the network, and apply the control signals to effect pairing of the wireless device with another device.

In another embodiment, a wireless device includes a speaker and logic to communicate a fixed pairing code it uses, either to the other device or for the user to enter on the other device.

### BRIEF DESCRIPTION OF THE DRAWINGS

The headings provided herein are for convenience only and do not necessarily affect the scope or meaning of the claimed invention.

In the drawings, the same reference numbers and acronyms identify elements or acts with the same or similar functionality for ease of understanding and convenience. To easily identify the discussion of any particular element or act, the most significant digit or digits in a reference number refer to the figure number in which that element is first introduced.

FIG. 1 is a block diagram of an embodiment of a device pairing arrangement.

FIG. 2 is a more detailed block diagram of the embodiment of a device pairing arrangement of FIG. 1.

FIG. 3 is a block diagram of another embodiment of a device pairing arrangement

FIG. 4 is a flow chart of an embodiment of acts of a pairing process.

FIG. 5 is a flow chart of an embodiment of acts of a pairing process.

FIG. 6 is a flow chart of an embodiment of acts of a pairing process.

FIGS. 7-9 are block diagrams of embodiments of portions of a network that may participate in a device pairing process.

### DETAILED DESCRIPTION

The invention will now be described with respect to various embodiments. The following description provides specific details for a thorough understanding of, and enabling description for, these embodiments of the invention. However, one skilled in the art will understand that the invention may be practiced without these details. In other instances, well known structures and functions have not been shown or described in detail to avoid unnecessarily obscuring the description of the embodiments of the invention.

Herein, “logic” refers to any information having the form of instruction signals and/or data that may be applied to affect the operation of a processing device. Examples of processing devices are computer processors (processing units), microprocessors, digital signal processors, controllers and microcontrollers, and so on. Logic may be formed from signals stored in a device memory. Software is one example of such logic. Examples of device memories that may comprise logic include RAM (random access memory), flash memories, ROMS (read-only memories), EPROMS (erasable programmable read-only memories), and EEPROMS. Logic may also be comprised by digital and/or analog hardware circuits, for example, hardware circuits comprising logical AND, OR, XOR, NAND, NOR, and other logical operations. Logic may be formed from combinations of software and hardware.

A “network element” is any one or more devices of a communication network, e.g. devices that participate at least occasionally in the operation of the network.

Typically, a subscriber will enter into contractual arrangements with a network operator for access rights to the operator's network(s).

Networks of this operator for which the subscriber has contractual access rights are the subscriber's “home networks.” Networks other than the home networks of the subscriber are “roaming networks.” The subscriber and the subscriber's wireless device are said to be “roaming” when accessing a roaming network.

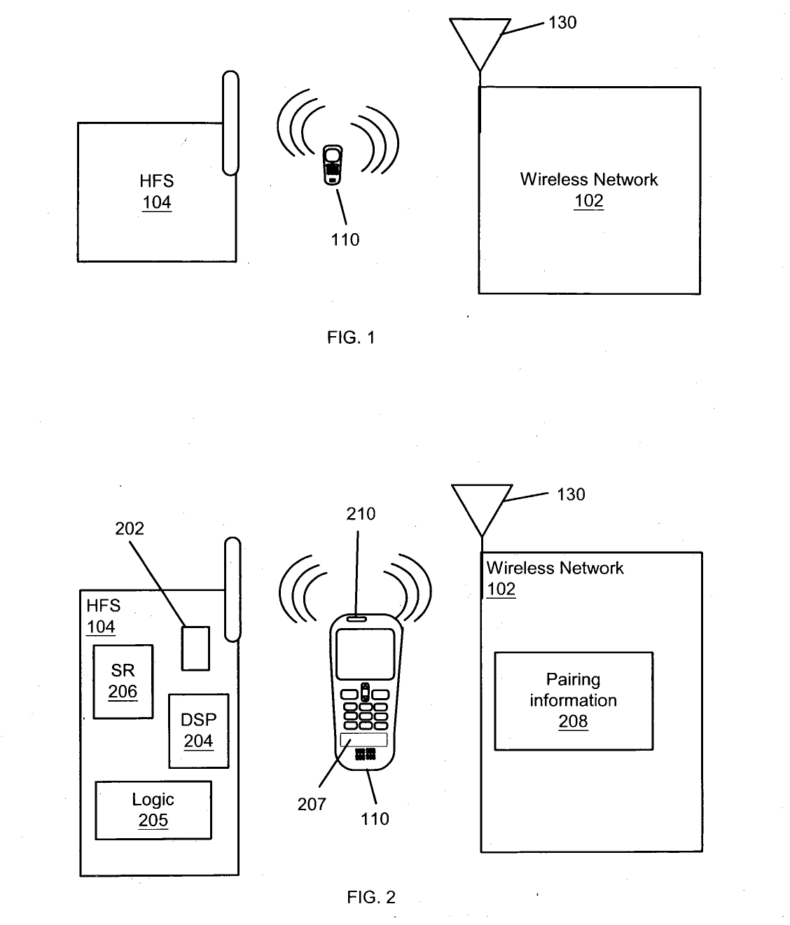

FIG. 1 is a block diagram of an embodiment of a wireless communication arrangement. A hands-free set (HFS) 104 communicates wirelessly with a telephone 110 using Bluetooth or other short-range wireless connection. The phone 110 may in turn simultaneously communicate wirelessly with a network 102 using GSM, or other wide-area wireless communications system. The wireless network 102 may receive signals from the phone 110 via an antennae 130. Pairing between the HFS 104 and the phone 110 guards against unauthorized use of the phone 110 by unwelcome parties.

FIG. 2 is a more detailed block diagram of the wireless communication arrangement of FIG. 1. The HFS 104 includes a microphone 202 to convert audible signals (sound waves) into electrical signals (or, conceivably, optical or other signal types), and a digital signal processor (DSP) 204 to process the electrical signals. Of course, other types of processors could be employed to process the electrical signals. The HFS 104 includes speech recognition logic 206, which when applied to the DSP 204, interpret the electrical signals into control signals of the HFS 104 (e.g. signals to affect the operation of the HFS 104). For example, the logic 206 may interpret electronic signals representing the spoken phrase “Press the Start Button” into one or more control signals with the effect of pressing the Start button of the HFS 104. Likewise, the logic 206 may interpret electronic signals representing the spoken phrase “Press One-Three-Three” into control signals with the effect of pressing the buttons 133 in sequence. The HFS 104 also comprises logic to effect acts of pairing with the phone. Likewise, the phone 110 comprises logic 207 to effect acts of pairing with the HFS 104.

The HFS 104 is not commonly provided with numeric keys or displays that would provide means to enter pairing codes or display commands and confirmations to the user during pairing, as these are typically not required during normal use of the device for making and receiving calls. Furthermore, the communication of audible signals between the devices to pair helps ensure proximity between the devices during the pairing process. Proximity helps ensure that third parties to not have the opportunity to intervene in the pairing process or perform unauthorized pairing using their own devices.

In one embodiment the phone 110 receives speech pairing signals for the HFS 104 from the wireless network 102. For example, the phone 110 could identify the type and model of the HFS 104 and pass that identity to the wireless network 102. The wireless network 102 locates pairing information for the identified device from a repository 208 of such information for various devices. The wireless network 102 communicates the pairing information for the HFS 104 to the phone 110 via speech signals (e.g. in the same manner that voice signals are communicated between phones and the network 102) or as data signals which are locally converted to speech signals on the phone, and data signals to ensure correct sequencing of the voice commands. The speech signals are communicated as audible signals by the speaker 210 of the phone 110. The audible signals enter the microphone 202 of the HFS 104 and are converted into control signals to effect pairing of the HFS 104 with the phone 110.

In another embodiment, DTMF a.k.a. “Touch Tone” signals are communicated as audible signals by the speaker 210 of the phone 110. The DTMF signals represent pairing commands and also possible a pairing code. This allows audible pairing of handsfree kits that do not comprise voice recognition but do comprise DTMF decoding capability.

In another embodiment, the repository 208 of pairing information for various devices may be comprised by the phone 110.

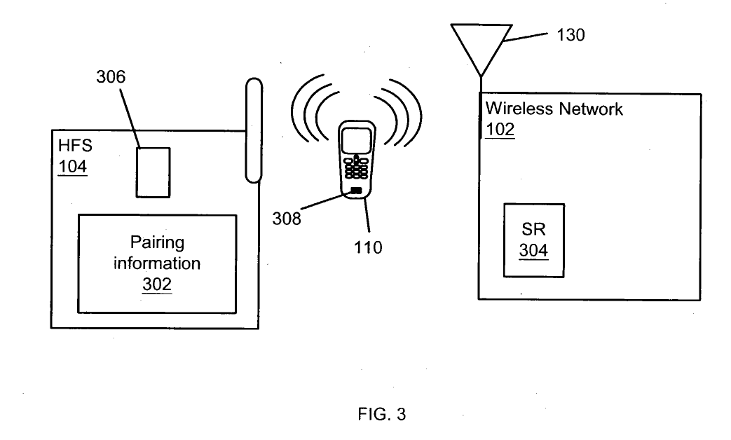

FIG. 3 is a block diagram of another embodiment of a wireless communication arrangement. The HFS 104 comprises pairing information 302. The pairing information 302 includes information to pair the HFS 104 with a variety of devices (for example, with a variety of makes and models of phones). The HFS 104 communicates to the phone 110 audible signals to pair the HFS 104 with the phone 110. The audible signals are communicated via the speaker 306 of the HFS 104. The audible signals are received by a microphone 308 of the phone 110. The phone 110 converts the audible signals into speech pairing signals and communicates the speech pairing signals to the network 102, where they are converted by the speech recognition logic 304 into control signals for the phone 110. The control signals are communicated to the phone 110 to effect pairing with the HFS 104.

In another embodiment, the information 302 comprises a pairing code (commonly four digits) either common to like models of the HFS 104 (or other device), or which is specific to the particular HFS 104 or other device.

In another embodiment, the pairing code communicated audibly by the HFS 104 or other device is intercepted by a human operator that is supervising the pairing process, and who then enters the pairing code into the phone or other device when prompted to do so.

The phone 110 and the HFS 104 may exchange signals to synchronize the pairing process. For example, the phone 110 may perform acts to begin the pairing process for the phone, and then signal the HFS 104 to perform acts that begin the pairing process for the HFS 104. Once the HFS 104 has performed these acts, the HFS 104 may signal the phone 110 to perform additional acts to pair the phone 110. The phone 110 may perform these additional acts and then signal the HFS 104, and so on.

In another embodiment, the phone 110 may comprise the speech recognition logic 304, and conversion of the speech pairing signals into control signals for the phone 110 may be performed by the phone 110.

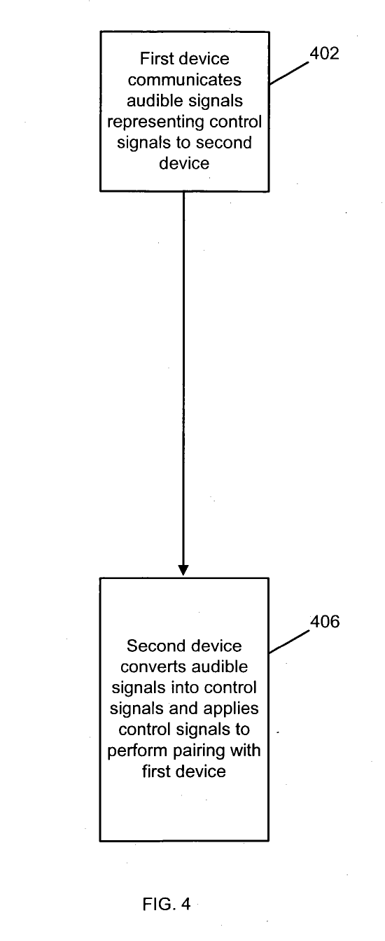

FIG. 4 is a flowchart of an embodiment of a pairing process. At 402 a first device communicates audible signals representing control signals to a second device. At 406 the second device converts the audible signals into control signals and applies the control signals to perform pairing with the first device.

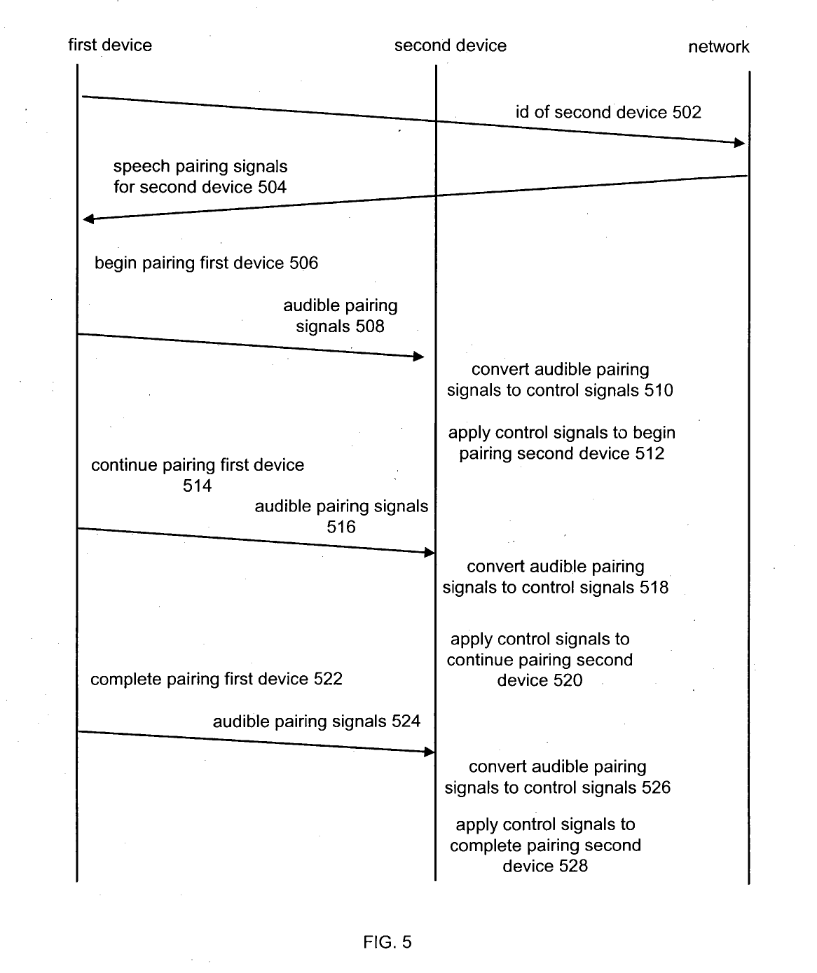

FIG. 5 is an action diagram of an embodiment of a pairing process. At 502 a first device communicates the id of a second device to a network. At 504 the network communicates to the first device speech pairing signals for the second device. At 506 the first device begins pairing with the second device. At 508, at an appropriate point in the pairing process, the first device communicates audible pairing signals to the second device. The audible pairing signals are derived from the speech pairing signals received from the network. At 510 the audible pairing signals are converted to control signals of the second device. At 512 the control signals are applied to begin pairing the second device with the first device.

At 514 the first device continues the pairing process with the second device. At 516, at an appropriate point in the pairing process, the first device communicates audible pairing signals to the second device. At 518 the audible pairing signals are converted to control signals of the second device. At 520 the control signals are applied to continue pairing the second device with the first device.

At 522 the first device completes the pairing process with the second device. At 524, at an appropriate point in the pairing process, the first device communicates audible pairing signals to the second device. At 526 the audible pairing signals are converted to control signals of the second device. At 528 the control signals are applied to complete pairing the second device with the first device.

In some embodiments the first device may signal the network at points of the pairing process where synchronization is involved with the second device. The network may in response communicate to the first device a next set of speech pairing signals for the second device. The first device may communicate audible signals representing the speech pairing signals to the second device at an appropriate point in the pairing process.

In some embodiments, the first device may receive control signals from the network to pair the first device with second device. The network may also communicate to the first device of speech pairing signals for the second device. The first device may communicate audible signals representing the speech pairing signals to the second device at appropriate points in the pairing process. In other words, the network may “drive” the pairing of both the first and second devices.

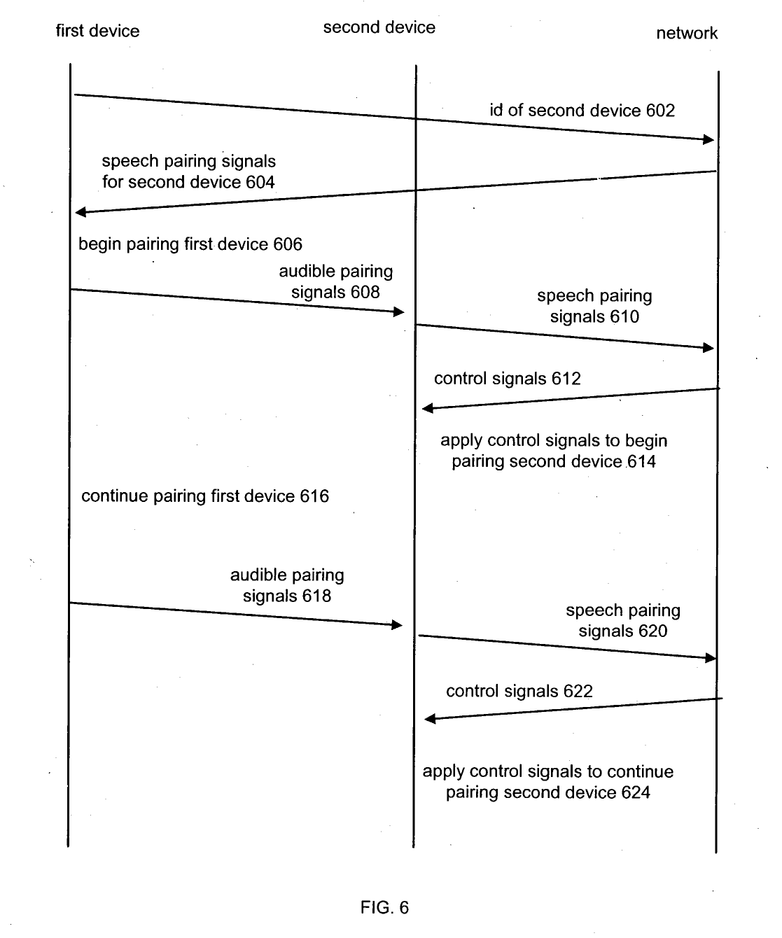

FIG. 6 is an action diagram of an embodiment of a pairing process. The first device begins the pairing process at 606, and at 608 communicates audible signals to the second device. At 610 the second device converts the audible signals into speech signals and communicates these signals to the network.

Communicating the speech pairing signals to the network offers some advantages. The network may comprise powerful computing devices that are more capable than the second device at performing speech recognition. The second device may thus be simpler and less expensive than a similar device with speech recognition capabilities. Encryption and other security techniques may be employed to discourage third parties from interfering with the exchange of signals between the device and the network.

At 612 the network communicates to the second device control signals corresponding to the speech pairing signals. At 614 the second device applies the control signals to begin pairing the second device with the first. The first device continues the pairing process at 616, and at 618, at an appropriate point in the pairing process, the first device communicates additional audible pairing signals to the second device. At 620 the second device converts the audible signals into speech signals and communicates these signals to the network. At 622 the network communicates to the second device control signals corresponding to the speech pairing signals. At 624 the second device applies the control signals to begin pairing the second device with the first.

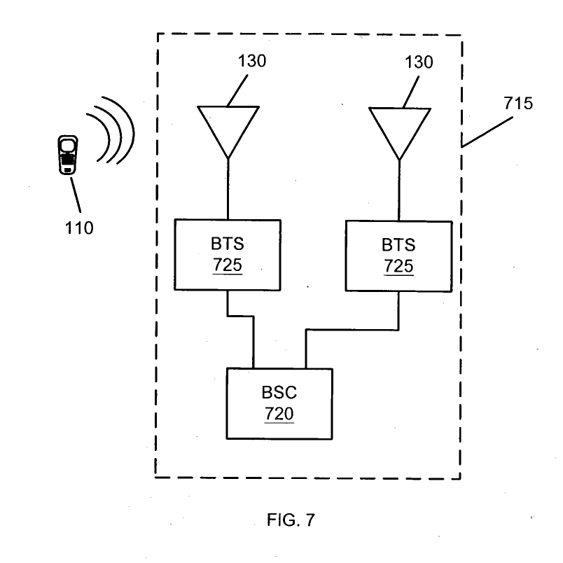

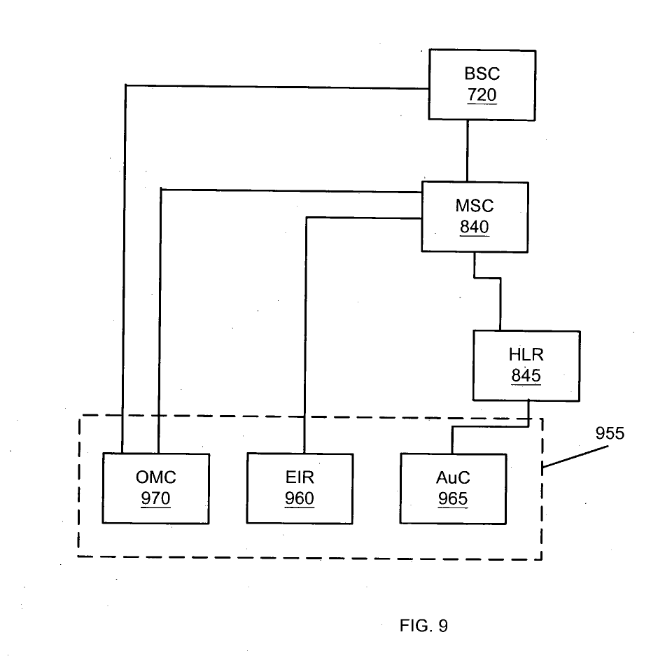

Embodiments of the wireless network 102 will now be described in conjunction with FIGS. 7-9. In the description, particular network elements are identified that may comprise the pairing information 208 and the speech recognition logic 304. These network elements are identified by way of example and not limitation, e.g. the pairing information 208 and the speech recognition logic 304 may be comprised as well by network elements other than those specifically identified in the figures.

FIG. 7 shows a block diagram of the base station subsystem of a wireless network 102. The base station subsystem (BSS) 715 consists of base station controllers (BSC) 720 coupled to one or more base transceiver stations (BTS) 725. In turn, each BTS 725 is coupled to one or more antennas 130.

The BTS 725 includes transmitting and receiving equipment to create a radio interface between the wireless network 102 and the wireless device 110. Although the antenna subsystem 130 is shown as a separate element for clarity, it is common in the industry to collectively refer to the antenna subsystem 130, transmitter, and receiver, as the BTS.

The BSC 720 may perform management of the radio interface by allocating channels, managing handover from one BTS to another, paging the wireless device, and transmitting connection-related signaling data.

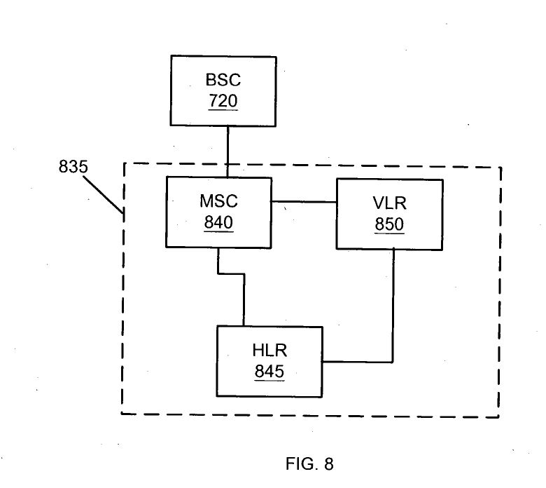

FIG. 8 is a block diagram of the networking and switching subsystem (NSS) 835 of a wireless network. The NSS 835 comprises a Mobile Switching Center (MSC) 840, a Home Location Registry (HLR) 845, and a Visitor Location Registry (VLR) 850. Switching and network management functions are carried out by the NSS 835. The NSS 835 may also act as a gateway between the wireless network and other networks such as the Public Switched Telephone Network (PSTN), Integrated Services Digital Network (ISDN), the Internet, other wireless networks, and the Public Data Network (PDN).

The MSC 840 is a digital switching mechanism that routes communications and manages the network. In GPRS networks, GPRS support nodes (GSNs) such as Switching GSNs (SGSNs) and Gateway GSNs (GGSNs) may provide switching operations similar to those provided by the MSC 840. There can be many MSC (switches) 840 in a communication network, each responsible for the signaling required to set up, maintain, and terminate connections to wireless devices 110 within the geographical area served by the MSC 840. Each MSC 840 may manage several BSC 720. The MSC 840 is coupled to a Home Location Registry (HLR) 845 and a Visitor Location Registry (VLR) 850. The HLR 845 is also coupled to the VLR 850.

Subscriber information, including telephone number, mobile station identification number, equipment type, subscription information, access priorities and authentication key, may be stored in HLR 845, which is essentially a database. Also, the HLR 845 may store certain dynamic or temporary subscriber data such as current Location Area (LA) of the subscriber's mobile station and Mobile Station Roaming Number (MSRN). Subscriber-related data is recorded in the HLR 845 from which all the billing and administrative information is extracted when needed by the cellular service provider. Some wireless networks have only one HLR 845 that serves all subscribers.

In one embodiment the HLR 845 comprises the pairing information 208 and the speech recognition logic 304 for the wireless devices of subscribers of the network.

The MSC 840 uses VLR 850 to manage the wireless devices that are currently roaming in the area controlled by MSC 840. The VLR 850 stores information such as the International Mobile Subscriber Identity (IMSI), authentication data, and telephone number of the roaming wireless devices. The VLR 850 obtains information about the services to which a roaming wireless device is entitled from the HLR that serves the wireless device. The VLR 850 controls a pool of MSRN and allocates an MSRN and Temporary Mobile Subscriber Identity (TMSI) to the roaming wireless device. The VLR 850 sends the MSRN and TMSI information to the HLR 845 where they are stored with dynamic subscriber information, for later use in call routing.

FIG. 6 is a block diagram of the operation subsystem (OSS) 955 of a wireless network 102. The OSS 655 includes an Equipment Identity Register (EIR) 960, an Authentication Center (AuC) 965, and an Operating and Maintenance Center (OMC) 970. The OSS 955 may provide subscription management, network operation, network maintenance, and mobile equipment management. The OSS 955 extracts call data from the HLR 845 in order to bill the subscriber.

The AuC 965 stores data related to network security and authentication of wireless devices and subscribers. The primary purpose of AuC 965 is to prevent fraud by verifying the identity of wireless devices and subscribers that try to access the network. Thus the AuC 965 may comprise authentication algorithms and encryption codes necessary to protect a subscriber's access rights and identity and to prevent eavesdropping.

The EIR 960 is a database which stores subscriber and International Mobile Equipment Identity (IMEI) numbers. Wireless devices are uniquely identified by an IMEI or equivalent number such as an Electronic Serial Number (ESN). An EIR 960 generally indicates the status of a particular wireless device by flags associated with its IMEI. An IMEI is typically flagged as one of either valid, stolen, suspended, or malfunctioning.

The OMC 970 monitors and controls other network elements to enhance system performance and quality. The OMC 970 also administers billing, subscriber service data, and generation of statistical data on the state and capacity of the network.

In one embodiment, one or more of the AuC 965, EIR 960, and OMC 970 may comprise come or all of the pairing information 208 and the speech recognition logic 304.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

1. A wireless device comprising:
pairing information for the wireless device;
pairing information for another wireless device;
a processor;
a speaker; and
logic which, when applied to the processor, converts the pairing information for the other wireless device to audible signals, and communicates the audible signals via the speaker.

2. The wireless device of claim 1 further comprising:
logic which, when applied to the processor, performs acts defined by the pairing information for the wireless device.

3. The wireless device of claim 2 further comprising:
logic which, when applied to the processor, synchronizes the acts defined by the pairing information for the wireless device with the communication of the audible signals via the speaker.

4. The wireless device of claim 1, the pairing information comprising a pairing code common to a model of the wireless device.

5. The wireless device of claim 1, the pairing information comprising a pairing code specific to the wireless device.

6. The wireless device of claim 1, wherein the logic converts the pairing information for the other wireless device to DTMF tones, and communicates the DTMF tones via the speaker.

8. A wireless device comprising:
a microphone;
a processor; and
logic which, when applied to the processor, converts signals produced by the microphone into control signals, and applies the control signals to effect pairing of the wireless device with another device.

9. The wireless device of claim 8 further comprising:
logic which, when applied to the processor, synchronizes the application of the control signals with pairing of the other device.

10. A wireless device comprising:
a processor;
a speaker; and
logic which, when applied to the processor, identifies another wireless device to a network, receives pairing information for the other wireless device from the network, converts the pairing information for the other wireless device to audible signals, and communicates the audible signals via the speaker.

11. The wireless device of claim 10 further comprising:
logic which, when applied to the processor, performs acts defined by pairing information for the wireless device.

12. The wireless device of claim 11 further comprising:
logic which, when applied to the processor, synchronizes the acts defined by the pairing information for the wireless device with the communication of the audible signals via the speaker.

13. The wireless device of claim 10, the pairing information comprising a pairing code common to a model of the wireless device.

14. The wireless device of claim 10, the pairing information comprising a pairing code specific to the wireless device.

15. The wireless device of claim 10, wherein the logic converts the pairing information for the other wireless device to DTMF tones, and communicates the DTMF tones via the speaker.

16. A wireless device comprising:
a microphone;
a processor; and
logic which, when applied to the processor, converts signals produced by the microphone into speech signals, communicates the speech signals to a network, receives control signals corresponding to the speech signals from the network, and applies the control signals to effect pairing of the wireless device with another device.

17. The wireless device of claim 16 further comprising:
logic which, when applied to the processor, synchronizes the application of the control signals with pairing of the other device.

18. A method comprising:
a first wireless device converting pairing information for a second wireless device into audible signals;
the first wireless device communicating the audible signals to the second wireless device;
the second wireless device converting the audible signals into control signals; and
the second wireless device applying the control signals to effect pairing with the first wireless device.

19. The method of claim 18 further comprising:
the second wireless device applying speech recognition logic to produce the control signals.

20. The method of claim 18 further comprising:
the first wireless device communicating synchronization signals to the second wireless device to synchronize pairing of the first and second wireless devices.

20. A method comprising:
a first wireless device receiving from a network pairing information for a second wireless device;
the first wireless device communicating the pairing information as audible signals to the second wireless device; and
the second wireless device converting the audible signals into control signals to effect pairing of the second wireless device with the first wireless device.

21. The method of claim 20 further comprising:
the second wireless device applying speech recognition logic to convert the audible signals into control signals.

22. The method of claim 20 further comprising:
the first wireless device pairing with the second wireless device in synchronization with communication of the audible signals.

23. A method comprising:
a first wireless device receiving from a network pairing information for a second wireless device;
the first wireless device communicating the pairing information as audible signals to the second wireless device; and
the second wireless device applying speech recognition logic to convert the audible signals to control signals which, when applied to the second device, effect pairing of the second wireless device with the first wireless device.

24. The method of claim 23 further comprising:
the first wireless device and the second wireless device exchanging signals to synchronize pairing of the first and second wireless devices.

25. A method comprising:
a first wireless device receiving audible signals from a second wireless device;
the first wireless device converting the audible signals to speech signals and communicating the speech signals to a network;
the first wireless device receiving from the network control signals corresponding to the speech signals; and
the first wireless device applying the control signals to effect pairing with the second wireless device.

26. The method of claim 25 further comprising:
the first wireless device exchanging signals with the second wireless device to effect pairing.

27. The method of claim 26 further comprising:
the second wireless device receiving from the network pairing information for the first wireless device; and
the second wireless device communicating the pairing information to the first wireless device as the audible signals.

28. A method comprising:
a first wireless device converting pairing information for a second wireless device into audible signals;
the first wireless device communicating the audible signals to a human;
the human providing inputs corresponding to the audible signals to the second wireless device;
the second wireless device converting the inputs into control signals; and
the second wireless device applying the control signals to effect pairing with the first wireless device.

29. The method of claim 28, the pairing information comprising a pairing code common to a model of the wireless device.

30. The method of claim 28, the pairing information comprising a pairing code specific to the wireless device.
